(19) United States
(12) Patent Application Publication
(10) Pub. No.: US 2006/0073926 A1
(43) Pub. Date: Apr. 6, 2006

(54) Non-circular rotary disk for a timing control drive

(75) Inventors: Peter Kelm, Herzogenaurach (DE); Andreas Moosmann, Nurnberg (DE); Frank Rettig, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: INA-Schaeffler KG, Herzogenaurach (DE)

(21) Appl. No.: 11/029,577

(22) Filed: Jan. 5, 2005

(30) Foreign Application Priority Data
Oct. 6, 2004 (DE) 2004 048 629.8

(51) Int. Cl. F16H 55/30; F16H 55/36

(52) U.S. Cl. 474/141

(57) ABSTRACT

A rotary disk which is rotatable through a rotation angle around a rotation axis, which includes a rotary disk contour having at least one elevation and a predetermined number of teeth arranged on the rotary disk contour with respective midpoints is provided. The midpoints of respective adjacent teeth having a predetermined spacing, a rotary disk radius which depends functionally on the angle of rotation in an average radius, and a rotary disk wrapping curve resulting therefrom, the average radius being chosen such that an arc length running around the rotary disk wrapping curve is equal to the product of the predetermined spacing of the midpoints of adjacent teeth and the number of teeth. A corresponding method for designing at least one rotary disk for a timing control drive, rotatable through a rotation angle around a rotation axis, is also provided.

### BACKGROUND

The invention relates to a non-circular rotary disk for a timing control drive and a method of construction and design of such a rotary disk. The present invention furthermore relates to a computer system for the design of such a rotary disk.

Synchronous drive systems, for example systems based on timing belts, are widely used in motor vehicles and also in industrial applications. In motor vehicles, timing belts or timing chains are used for driving camshafts which open and close the engine inlet and outlet valves. Other devices, such as for example water and fuel pumps, can also be driven by such a belt or chain.

So-called run vibrations in such wrapping drives represent system-specific effects. In principle, a tension means used in wrapping drives, such as for example a chain or a belt, can be excited to transverse, longitudinal and torsional vibrations. Such vibrations of the tension means can sensitively disturb the operation of a whole drive system. Their occurrence leads to noise and increased structural loads of components of the drive system due to dynamic force peaks, which shorten the lifetime of the whole system. Furthermore when striking of the belt run on adjacent parts is produced due to transverse vibrations, these parts and also the belt itself can be damaged. A failure of the whole drive system can already result after a short time. Such run vibrations are excited by an unevenly running driving torque of the internal combustion engine. In addition, fluctuations of the belt or chain tensions may occur, and can also cause higher wear and a shorter lifetime of the belt or chain.

It is known to provide non-circular belt pulleys in such drive systems, to seek to avoid or exclude such vibrations. From DE-A 195 20 508 there is known a revolving belt drive system for an internal combustion engine, in which a control belt runs around two driven belt pulleys coupled to the camshaft of an engine and around a drive belt pulley which is coupled to a crankshaft of the engine. It is proposed there to reduce torsional vibrations by means of a non-circular belt pulley, which is shown as a camshaft belt pulley.

In the Utility Model document DE 203 19 172, a non-circular rotary component is disclosed, which consists of a rotor with plural teeth arranged on the circumference of the rotor, each tooth having a crown and a recess being located between each pair of adjacent teeth, and the crowns of the teeth being located on a curved periphery forming the circumference of the rotor. The periphery of the rotor has a non-circular profile with at least two projecting regions which alternate with recessed regions. The distance between the midpoints of the crowns of each pair of adjacent teeth, and furthermore the profile of the recesses between each pair of adjacent teeth, is substantially equal. The distance between the midpoint of each crown and the axis of the rotor varies on the circumference, in order to achieve the non-circular profile.

The design of non-circular disks for positive tension means drives is thus admittedly described; however, the described arrangement contains methodical weaknesses. Thus the Utility Model document starts from a basic contour in the form of a polygon. This means that a non-circular disk provided with teeth has an envelope line which is approximated by a polygon. Based on this arrangement, a chord length for chain drives, and an arc length for toothed drives, is used in the further design of the disk. Furthermore a strongly deformed tooth contour results from oblique positioning of the teeth arranged on the disk.

### SUMMARY

The object of the present invention is, in view of the background of the cited prior art, to provide a rotary disk and a corresponding method for the design of such a rotary disk, in order to eliminate these disadvantages.

Starting from the cited prior art and the considerations to be derived therefrom, the present invention provides a non-circular rotary disk and a method for designing such a rotary disk according to the invention, as well as a computer program and a computer system for such design.

According to the invention, a rotary disk is provided which is rotatable through a rotation angle around a rotation axis, the rotary disk having a rotary disk circumference having at least one elevation, a predetermined number of teeth with respective midpoints, the midpoints of respective adjacent teeth having a predetermined spacing, a rotary disk radius which depends functionally on the angle of rotation and an average radius, and has a rotary disk wrapping curve resulting therefrom, the average radius being chosen such that an arc length of the rotary disk wrapping curve is equal to the product of the predetermined distance of the midpoints of adjacent teeth and the number of teeth.

In the context of the invention, “non-circular” means that the radius of the disk is not constant, which can be accompanied by a non-uniform transmission. Due to a non-circular rotary disk, a control drive can undergo an excitation, i.e., a vibrational excitation, which results from the disk shape, i.e., not the ideal round shape. Such non-circular disks can, as already mentioned at the beginning, be used for the elimination of rotational vibrations in control drive systems. The causes of such rotational vibrations can lie, among other things, in a combustion process of an engine or in unequal drive torques of other assemblies such as pumps, for example. In such systems, a correct positioning and profiling of teeth of a corresponding rotary disk becomes of great importance, in order to avoid undesired loadings of a tension mans used, such as for example a belt or a chain, in contact with the rotary disk or with the wheel. A shortened lifetime of the tension means would otherwise be the consequence.

Through the use of a rotary disk according to the invention, the vibrational behavior of wrapping drives which are designed as drives with non-uniform transmission is damped down. Examples of this are found, e.g., in control and assembly drives used in automobile construction. The rotary disks according to the invention are however usable independently of the application, for example, also in regions of textile or office machines.

In the rotary disk according to the invention, the length swept over for a 360° rotation of the rotary wrapping curve is equal to the circumference of a round disk which is given by the product of the predetermined number of teeth and the predetermined respective distance between adjacent teeth, where for calculation of the length of the rotary disk wrapping curve the rotation angle and the rotary disk radius are used. There results a specific average radius, which however can vary according to the functional formulation for the rotary disk radius. It is thereby attained that the circumference of the non-circular rotary disk in the plane of action corresponds exactly to that of a circular disk. The exact determination of the circumference, or respectively of the length of the rotary disk wrapping curve swept over with a 360° rotation, is important, since a transmission ratio is thereby determined in a direct manner and this is functionally relevant to this extent. Thus for example in an automobile timing control drive, the transmission between a crankshaft used and a correspondingly used camshaft must be exactly 2:1.

In a further possible embodiment of the rotary disk according to the invention, the rotary disk radius can be expressed by a harmonic expansion of the following form:

$$r ( t ) = {r}_{average} + {\sum }_{i} δ n cos ( {n}_{i} t + φ t )$$

where r_{average} is the average radius, δrᵢ is a non-circularity amplitude, nᵢ is the number of elevations of the rotary disk circumference, ψ is a phase position and t is a parameter running over the interval of 0 to 2π. The average radius is, as already mentioned, not constant but variable. The average radius can for example vary, for example in dependence on the chosen number of elevations n, also herein-after termed the order, the phase positions ψ, or also the non-circularity amplitude δrᵢ. The rotary wrapping curve, as a space curve, can be given in coordinate form by means of the angle-dependent radius as given below:
(x(t), y(t))=(r(t)cos(t), r(t)sin(t))

The average radius may now be determined, in that the arc length swept over with a 360° rotaton of the rotary disk wrapping curve given in the parametric form (x(t), y(t)) is calculated, namely by performing an integration of the arc length differential over an interval from 0 to 2π, and the resulting arc length is equated with the product of the predetermined number Z of teeth and the predetermined spacing D of respective adjacent teeth:

$$ZD = {\int }_{0}^{2 π} \sqrt{( {x}^{2} ( t ) + {y}^{2} ( t ) )} ⅆ t$$

An arc length between two teeth is hereby accordingly used in the form of a rotary disk wrapping curve section instead of the chord length or the spacing of two midpoints of adjacent teeth. This approach is expensive as a method, but however leads to correct results with increasing non-circularity. It should be remarked here that with chain drives, the chord length has to be used instead of the arc length, since here a so-called polygon effect operates because of the rigidity of the individual chain members.

In a further conceivable embodiment of the rotary disk according to the invention, the teeth of the rotary disk are aligned such that their respective midlines are perpendicular to the rotary disk wrapping curve tangent coinciding with the respective midpoint of the teeth. Such an alignment of the teeth can considerably reduce the loading of a tension means used, arising where possible. With an alignment over a polygon of the tooth gaps resulting between the teeth, the profile of the teeth is distorted. Such a distortion in its turn stresses a tension means used. A residual deformation nevertheless remaining can be remedied if necessary by a position-dependent, and thus radius-dependent, variation of the tooth profile.

In another embodiment of the rotary disk according to the invention, a wrapping arc formed by a tension means at least partially wrapping around the rotary disk always follows the rotary disk wrapping curve. This means that the wrapping arc formed by the tension means has the greatest possible contact with the rotary disk. This furthermore means that the rotary disk wrapping curve always has a non-negative curvature.

The present invention furthermore relates to a method for designing at least one rotary disk for a control drive, rotatable through a rotation angle around a rotation axis, the at least one rotary disk having a rotary disk contour having at least one elevation, a predetermined number of teeth arranged on the rotary disk contour with midpoints, the midpoints of the respective adjacent teeth having a predetermined spacing, a rotary disk radius depending functionally on the rotation angle and an average radius, and a rotary disk wrapping curve resulting therefrom. In the method, the average radius is determined such that a wrapping arc length of the rotary disk wrapping curve is equal to the product of the predetermined spacing of the midpoints of adjacent teeth and the predetermined number of teeth.

In one embodiment of a method according to the invention, the rotary disc radius is determined by a harmonic expansion of the following form:

$$r ( t ) = {r}_{average} + {\sum }_{i} δ {r}_{i} cos ( {n}_{i} t + φ t )$$

wherein r_{average} is the average radius, δrᵢ is a non-circularity amplitude, nᵢ is the number of elevations, φᵢ is a phase length, and t is a parameter running over an interval of 0 to 2π. The average radius r_{average} is variable and is separately determined for a given formulation, that is, for a given choice of the number of elevations, that is, the order, the phase positions or the non-circularity amplitudes.

It is furthermore conceivable to align the teeth such that their respective midline is perpendicular to the tangent of the rotary disk wrapping curve adjacent to the respective midpoint of the teeth.

It is furthermore conceivable to choose the rotary disk contour such that the rotary disk wrapping curve resulting therefrom always has a non-negative curvature. It is thereby attained that a tension means wrapping the rotary disk has the greatest possible contact with the rotary disk.

The present invention furthermore relates to a product for performing the method according to the invention, the product being a computer program with program code which when the computer program is run on a computer is suitable for performing a method according to the invention. The computer program can be stored on a computer-readable medium.

Furthermore a computer-readable data carrier with a computer program stored thereon is provided and includes a program code which when the computer program runs on a computer is suitable for performing a method according to the invention.

Furthermore, a computer system with a memory means is provided in which a computer program with program code is stored which, when the computer program runs on a computer, is suitable for performing a method according to the invention.

It will be understood that the features named above and still to be explained hereinafter are usable not only in the recited combinations, but also in other combinations or alone, without departing from the scope of the invention.

### BRIEF DESCRIPTION OF THE DRAWINGS

The invention is described in detail with reference to the accompanying drawing on the basis of a preferred embodiment.

FIG. 1 is a schematic diagram of an embodiment of a rotary disk according to the invention.

### DETAILED DESCRIPTION OF THE PREFERRED EMBODIMENT

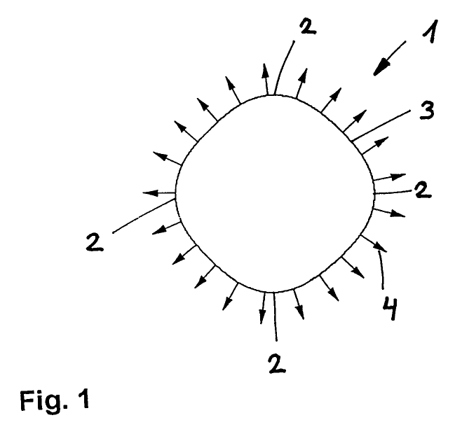

FIG. 1 shows a non-circular rotary disk 1. The rotary disk 1 has four elevations 2. Furthermore, a predetermined number Z of teeth 4 are arranged on the rotary disk contour 3. In the case shown here, 21 teeth are provided on the rotary disk contour 3. A minimum diameter dₘᵢₙ and a maximum diameter dₘₐₓ can then be determined, and therefrom a diameter difference Δd. In the present case, the diameter difference Δd is predetermined as 5 mm. The number n of the elevations 2 corresponds to the order, which is thus 4 here. By means of this data, a rotary disk wrapping curve can now be given as a space curve in the form (x(t), y(t)) in a first approximation as follows:

$$x ( t ) = r ( t ) cos ( t ) = ( {r}_{average} + \frac{Δ d}{4} cos ( nt ) ) cos ( t )$$

$$x ( t ) = r ( t ) sin ( t ) = ( {r}_{average} + \frac{Δ d}{4} sin ( nt ) ) sin ( t )$$

where a phase position φ of 0 was assumed. The non-circularity amplitude δr is given as Δd/4. Furthermore a spacing D between two midpoints of adjacent teeth, a so-called pitch, was predetermined as 9.525 mm.

By integrating the differential of the arc length of the rotary disk wrapping curve over an interval of 0 to 2π:

$${\int }_{0}^{2 π} \sqrt{( {x}^{2} ( t ) + {y}^{2} ( t ) )} ⅆ t$$

and setting it equal to the product of the predetermined number of teeth Z and the predetermined pitch D:

$$ZD = {\int }_{0}^{2 π} \sqrt{( {x}^{2} ( t ) + {y}^{2} ( t ) )} ⅆ t$$

there results an average radius:
r_{average}=31.6383
from which the disk contour results as:
   x(t)=(31.6383+1.25 cos(4t)) cos(t) for ιe [0, 2π]
   y(t)=(31.6383+1.25 cos(4t)) sin(t) for ιe [0, 2π]

It can be seen that according to the chosen or suitable functional formulation of the angle-dependent radius, another average radius results. Thus the average radius, and the angle-dependent radius coupled to it, is always adapted to the system on which they are based. The respective resulting rotary disk wrapping curve is accordingly very flexibly adapted to the existing defaults. The exact determination of the average radius or the length of the rotary disk wrapping curve as an image of the non-circular contour of the rotary disk is very relevant to function and is in direct relationship to a transmission ratio of the rotary disk. Thus, for example, a transmission ratio between a crankshaft and a camshaft must be exactly 2:1 in a motor vehicle control drive. Only by exact determination of the average radius or the rotary disk wrapping curve can such defaults be correctly attained.

Furthermore, an alignment of teeth takes place so that the midline of a tooth is perpendicular to the tangent to the rotary disk wrapping curve. A small residual deformation nevertheless possibly remains which could be eliminated by variation of the tooth profile in dependence on position and thus on radius.

Furthermore, a tension means is to contact the disk as much as possible over the whole course of its wrapping arc. This means that a wrapping arc formed by a tension means at least partially wrapping the rotary disk always follows the rotary disk wrapping curve. This is equally important to the requirement that the rotary disk wrapping curve is always to have a non-negative curvature.

This requirement is always to be taken into account in the choice of the parameters in the presented harmonic formulation.

The present invention has in all aspects many embodiments in devices which require a non-circular disk; in particular, it finds application in synchronous drive devices. Here an internal combustion engine may be concerned, for example. The invention is however also applicable to devices other than synchronous drive devices. The non-circular or unround shape of the rotary disk can be provided at many different places in a drive device. The choice of the rotary disk contour depends on other components of a drive device. A uniform non-circular profile or a non-uniform profile or contour for the rotary disk can thus result. A tension means and the rotary disk must be matched to each other as well as possible for reasons of power and lifetime.

1. Rotary disk which is rotatable by an angle of rotation around a rotation axis, the rotary disk comprising a rotary disk contour having at least one elevation, a predetermined number of teeth arranged on the rotary disk contour with respective midpoints, the midpoints of respective adjacent teeth having a predetermined spacing, a rotary disk radius which depends functionally on the angle of rotation and an average radius, and a rotary disk wrapping curve resulting therefrom, the average radius being chosen such that an arc length around the rotary disk wrapping curve is equal to a product of the predetermined spacing of the midpoints of adjacent teeth and the number of teeth.

2. Rotary disk according to claim 1, wherein the rotary disk radius is expressed by a harmonic expansion of the following form:
$$r ( t ) = {r}_{average} + {\sum }_{i} δ n cos ( {n}_{i} t + φ )$$
where herein:
r_{average}=the average radius,
δrᵢ=a non-circularity amplitude,
nᵢ=the number of elevations,
φ=a phase position, and
t =a parameter running over the interval of 0 to 2π.

3. Rotary disk according to claim 1, wherein the teeth are aligned such that a respective midline is perpendicular to a tangent to the rotary disk wrapping curve abutting at the respective midpoint of the teeth.

4. Rotary disk according to claim 1, wherein a wrapping arc formed by a tension means at least partially wrapping around the rotary disk always follows the rotary disk wrapping curve.

5. Rotary disk according to claim 1, wherein the rotary disk wrapping curve always has a non-negative curvature.

6. Method for designing at least one rotary disk for a timing control drive, that is rotatable by a rotation angle around a rotation axis, the at least one rotary disk comprising a rotary disk contour having at least one elevation, a predetermined number of teeth arranged on the rotary disk contour with midpoints, the midpoints of the respective adjacent teeth having a predetermined spacing, a rotary disk radius depending functionally on the rotation angle and an average radius, and a rotary disk wrapping curve resulting therefrom, the method comprising determining the average radius such that an arc length running around the rotary disk wrapping curve is equal to a product of the predetermined spacing of the midpoints of adjacent teeth and the predetermined number of teeth.

7. Method according to claim 6, further comprising determining the rotation disk radius by a harmonic expansion of the following form:
$$r ( t ) = {r}_{average} + {\sum }_{i} δ n cos ( {n}_{i} t + φ )$$
where
r_{average}=the average radius,
δrᵢ=a non-circularity amplitude,
nᵢ=the number of elevations of the rotary disk circumference,
φ=a phase position, and
t=a parameter running over the interval of 0 to 2π.

8. Method according to claim 6, further comprising aligning the teeth such that a respective midline is perpendicular to a tangent to the rotary disk wrapping curve at the respective midpoint of the teeth.

9. Method according to claim 6, further comprising selecting the rotary disk contour such that the rotary disk wrapping curve derived therefrom always has a non-negative curvature.

10. Product for performing the method according to claim 6, comprising a computer system having a computer program with program code, which when running the computer program includes means for determining the average radius such that an arc length running around the rotary disk wrapping curve is equal to a product of the predetermined spacing of the midpoints of adjacent teeth and the predetermined number of teeth.

11. Product according to claim 10, wherein the computer program is stored on a computer-readable medium.

12. Computer-readable data carrier with stored thereon a computer program comprising a program code which, when running the computer program on a computer, is suitable for performing a method according to claims 6.

13. Computer system with a memory means in which a computer program with program code is stored, which when the computer program runs on a computer is suitable for performing a method according to claim 6.
